(19) United States
(12) Patent Application Publication
(10) Pub. No.: US 2003/0099745 A1
(43) Pub. Date: May 29, 2003

(54) Food washing composition

(75) Inventors: Dale Albert Grinstead, Fairfield, OH (US); Petrus Adrianus Angevaare, Cincinnati, OH (US)

Correspondence Address: UNILEVER, PATENT DEPARTMENT, 45 RIVER ROAD, EDGEWATER, NJ, 07020, US

(73) Assignee: Diversey Lever, Inc.

(21) Appl. No.: 09/995,553

(22) Filed: Nov. 28, 2001

(51) Int. Cl. A23K 1/00

(52) U.S. Cl. 426/335

(57) ABSTRACT

A composition for washing foods is described. The composition has an organic acid, inorganic acid, and surfactant, and the composition is substantially free of alcohol. Also, the composition is non-flammable, generally regarded as safe, and an anti-microbial agent.

### FIELD OF THE INVENTION

The present invention is directed to a composition for washing foods. More particularly, the present invention is directed to a composition that may be used to wash fish, meats, poultry, fruits, vegetables, and the like wherein the composition is substantially free of alcohol.

### BACKGROUND OF THE INVENTION

It is well-known and appreciated by consumers that foodstuffs, like fish, meats, poultry, fruits, vegetables, and the like should be thoroughly washed prior to eating. This is true because such foodstuffs can be contaminated with, for example, soil, insecticides and even microbes. Additionally, with respect to fruits and vegetables, many consumers wish to remove any artificial moisture retaining coatings (e.g., wax coatings) that have been applied to the surfaces of the fruits and vegetables.

Cleaning solutions for washing foodstuffs are known. Such solutions, however, are not deplete of drawbacks since they are often formulated with alcohols and not always generally recognized as safe. Moreover, due to the presence of alcohols, conventional food cleaning solutions can be flammable.

Other solutions for washing foodstuffs are known and they employ high concentrations of organic active (e.g., about 1.0% or more) and/or components like hypochlorite which often alters the taste and texture of the foodstuff being washed.

In addition to the drawbacks described above, conventional food cleaning solutions are not always effective anti-microbial agents.

It is of increasing interest to develop a food washing composition that is safe to use, and effective at eliminating anti-microbial activity on foodstuffs. This invention, therefore, is directed to a food washing composition that is substantially free of alcohol, non-flammable, generally regarded as safe, and an excellent anti-microbial agent. Moreover, the food washing composition of the present invention unexpectedly is an excellent foodstuff wash while employing about ten (10) times less active than conventional organic acid-based compositions.

Additional Information

Efforts have been disclosed for preparing cleaning compositions. In U.S. Pat. No. 5,280,042, disinfecting and sanitizing compositions for hygiene uses, and vegetable and fruit washes are disclosed.

Other efforts have been disclosed for preparing cleaning compositions. In U.S. Pat. No. 4,808,330, non-toxic detergent compositions for fruits and vegetables are disclosed.

Still other efforts have been disclosed for preparing cleaning compositions. In World Patent Application WO 00/30460, cleaning compositions suitable for reducing microorganisms are disclosed.

### SUMMARY OF THE INVENTION

In a first aspect, the present invention is directed to a composition for cleaning foodstuff, the composition comprises:

(a) an organic acid;

(b) an inorganic acid; and

(c) a surfactant

wherein the composition is substantially free of alcohol and the composition results in a use solution having a pH that is below the pKa of the organic acid.

In a second aspect, the present invention is directed to a method for washing foodstuff.

As used herein, alcohol is defined to mean compound or polymer having an OH group and not having a carboxylic acid group. Foodstuff, as used herein, is meant to include fruit, vegetables, fish, meat, poultry, and the like. Composition for cleaning foodstuff is defined to mean a composition for cleaning foodstuff wherein the composition is generally regarded as safe, and comprising from about 0.0 to about less than 10.0%, and preferably, from about 0.0 to less than about 2.5% by weight percarboxylic acid, based on total weight of the composition for cleaning foodstuff. Substantially free means less than about 1.0%, and preferably, less than about 0.05% by weight, based on total weight of the composition for cleaning foodstuff.

### DETAILED DESCRIPTION OF THE PREFERRED EMBODIMENTS

There is no limitation with respect to the organic acid used in this invention other than that the organic acid is one which may be used in a composition suitable for cleaning foodstuff. Illustrative examples of the organic acids which may be used in this invention include acetic acid, citric acid, propionic acid, lactic acid, mixtures thereof and the like. The preferred organic acid used in the composition for cleaning foodstuff in this invention is, however, lactic acid.

Regarding the amount of organic acid used in this invention, often, from about 1.0 to about 85.0%, and preferably, from about 3.0 to about 75.0%, and most preferably, from about 30.0 to about 50.0% by weight organic acid is used, based on total weight of the composition for cleaning foodstuff, and including all ranges subsumed therein.

The inorganic acids which may be used in this invention include sulfuric, phosphoric, nitric acid, mixtures thereof and the like, with phosphoric acid being especially preferred.

The amount of inorganic acid used is typically from about 5.0 to about 60.0%, and preferably, from about 10.0 to about 50.0%, and most preferably, from about 15.0 to about 40.0% by weight, based on total weight of the composition for cleaning foodstuff; and including all ranges subsumed therein.

In an especially preferred embodiment, the total amount of organic acid and inorganic acid employed results in a composition for cleaning foodstuff having a pH of less than about 3.0, and preferably, less than about 2.0.

The surfactant that may be used in the present invention is limited only to the extent that it is one which may be used in a composition for cleaning foodstuff, whereby such surfactants can be cationic, nonionic, anionic, amphoteric or zwitterionic.

The cationic surfactants which may be used in this invention include those comprising amino or quaternary ammonium hydrophilic moieties which are positively charged when dissolved in the composition for cleaning foodstuff of the present invention.

Among the quaternary ammonium-containing surfactants that may be used are quaternary ammonium salts including dialkyldimethylammonium chlorides and trialkylmethylammonium chlorides, wherein the alkyl groups have from about 12 to about 22 carbon atoms and are derived from long-chain fatty acids, such as hydrogenated tallow fatty acid. Examples of quaternary ammonium salts useful in the present invention include ditallowdimethyl ammonium chloride, ditallowdimethyl ammonium methyl sulfate, dihexadecyl dimethyl ammonium chloride, di(hydrogenated tallow) dimethyl ammonium chloride, dioctadecyl dimethyl ammonium chloride, dieicosyl dimethyl ammonium chloride, didocosyl dimethyl ammonium chloride, di(hydrogenated tallow) dimethyl ammonium acetate, dihexadecyl dimethyl ammonium chloride, dihexadecyl dimethyl ammonium acetate, ditallow dipropyl ammonium phosphate, ditallow dimethyl ammonium nitrate, di(coconutalkyl) dimethyl ammonium chloride, and stearyl dimethyl benzyl ammonium chloride.

Salts of primary, secondary and tertiary fatty amines may also be used as the cationic surfactant in the composition for cleaning foodstuff of the present invention. The alkyl groups of such amines preferably have from about 12 to about 22 carbon atoms, and may be substituted or unsubstituted. Secondary and tertiary amines are preferred, and tertiary amines are particularly preferred. Such amines, useful herein, include stearamido propyl dimethyl amine, diethyl amino ethyl stearamide, dimethyl stearamine, dimethyl soyamine, soyamine, myristyl amine, tridecyl amine, theyl stearylamine, N-tallowpropane diamine, ethoxylated (e.g., 5 moles E.O.) stearylamine, dihydoxy ethyl stearylamine, and arachidylbehenylamine. Suitable amine salts include the halogen, acetate, phosphate, nitrate, citrate, lactate and alkyl sulfate salts. Such salts include stearylamine hydrochloride, soyamine chloride, stearylamine formate, N-tallowpropane diamine dichloride and stearamidopropyl dimethylamine citrate.

These types of cationic surfactants are further described in U.S. Pat. Nos. 3,939,678, 3,959,461, 4,275,055 and 4,387,090, the disclosures of which are incorporated herein by reference.

The nonionic surfactants which may be used in the composition for cleaning foodstuff of this invention may be broadly defined as compounds produced by the condensation of alkylene oxide groups with an organic hydrophobic compound which may be aliphatic or alkyl aromatic in nature.

Polyethylene oxide condensates of alkyl phenols are often preferred nonionic surfactants as are ethylene oxide comprising surfactants which comprise from about 10 to about 60 moles of ethylene oxide per mole of alkyl phenol. The alkyl substituent in such compounds may be derived, for example, from polymerized propylene, diisobutylene, octane, or nonane.

The nonionics derived from ethylene oxide which may be used include those containing from about 40% to about 80% polyoxyethylene by weight and having a molecular weight from about 5,000 to about 11,000. Such nonionics result from the reaction of ethylene oxide groups and a hydrophobic base consisting of the reaction product of ethylene diamine and excess propylene oxide, the base having a molecular weight from about 2,500 to about 3,000.

Still other nonionics which may be used include tertiary amine oxides, tertiary phosphine oxides, dialkyl sulfoxides, polyalkylene oxide modified dimethylpolysiloxanes, dimethicone copolyols and the like. A more detailed description of such nonionics may be found in U.S. Pat. No. 5,120,532, the disclosure of which is incorporated herein by reference.

The anionics which may be used in this invention include, for example, alkyl and alkyl ether sulfates, succinanates, olefinsulfonates and the like. The preferred anionic used is, however, sodium dodecyl sulfate.

As to the amphoteric surfactants which may be used in the composition for cleaning foodstuff of the present invention, they include those which are broadly described as derivatives of aliphatic secondary and tertiary amines in which the aliphatic radical can be straight or branched chain and wherein one of the aliphatic substituents contains from about 8 to about 18 carbon atoms and one contains an anionic water solubilizing group, e.g., carboxy, sulfonate, sulfate, phosphate, or phosphonate. Examples of compounds falling within this definition are sodium 3-dodecyl-aminopropionate, sodium 3-dodecylaminopropane sulfonate, sodium lauryl sarcosinate, N-alkyltaurines such as the one prepared by reacting dodecylamine with sodium isoethionate according to the teaching of U.S. Pat. No. 2,658,072, N-higher alkyl aspartic acids such as those produced according to the teaching of U.S. Pat. No. 2,438,091, and the products sold under the trade name “Miranol” and described in U.S. Pat. No. 2,528,378, wherein the disclosures of all are incorporated herein by reference.

The zwitterionic surfactants which may be used in this invention include those which can be broadly described as derivatives of aliphatic quaternary ammonium, phosphonium, and sulfonium compounds, in which the aliphatic radicals can be straight or branched chain, and wherein one of the aliphatic substituents contains from about 8 to about 18 carbon atoms and one contains an anionic group, e.g., carboxy, sulfonate, sulfate, phosphate, or phosphonate.

Examples of such zwitterionic surfactants include:

4-[N,N-di(2-hydroxyethyl)-N-octadecylammonio]-butaine-1-carboxylate; 5-[S-3-hydroxypropyl-S-hexadecylsulfonio]-3-hydroxypentane-1-sulfate; and 3-[P,P-diethyl-P-3,6,9-trioxatetradexocylphosphonio]-2-hydroxy-propane-1-phosphate.

Regarding the amount of surfactant used, typically from about 0.01 to about 20.0%, and preferably, from about 0.03 to about 10.0%, and most preferably, from about 0.04 to about 5.0% by weight surfactant is used, based on total weight of the composition for cleaning foodstuff, including all ranges subsumed therein.

There generally is no limitation with respect to how the composition for cleaning foodstuff is made as long as all the components (e.g., organic acid, inorganic acid, surfactant) are mixed and water is added as the balance.

Subsequent to preparing the composition for cleaning foodstuff of the present invention, one part of the composition is diluted with at least about 450 parts water; and preferably, at least about 750 parts water; and most preferably, at least about 950 parts water to produce a ready to use or in use foodstuff wash having a pH of less than about 3.5, and preferably, less than about 3.0, and most preferably less thab about 2.75. The foodstuff wash may then be contacted with the foodstuff targeted for cleaning in order to produce clean or substantially soil free foodstuff. It is noted herein that there is no limitation with respect to how long the foodstuff wash and foodstuff targeted for cleaning (i.e., soiled foodstuff) are in contact, as long as the entire surface of the soiled foodstuff comes into contact with the foodstuff wash. Typically, however, the foodstuff wash and soiled foodstuff are in contact for a period of time from about 1.0 second to about one (1) hour, and preferably, from about 2.5 seconds to about 15 minutes, and most preferably, from about 5.0 seconds to about 5 minutes, including all ranges subsumed therein.

There is no limitation with respect to how the soiled foodstuff is contacted with the foodstuff wash of the present invention other than that substantially the entire surface of the soiled foodstuff is contacted with the composition. Typically, however the foodstuff wash of the present invention is sprayed (e.g., with a trigger spray dispenser or eductor), dipped (e.g., in a sink) or brushed on to the soiled foodstuff. In a most preferred embodiment, however, the foodstuff wash of the present invention is utilized in a flume or aqueous transport stream during the transportation of soiled foodstuff, like fruits and vegetables, and the soiled foodstuff is contacted with the foodstuff wash of the present invention within the flume. After the contacting step, clean foodstuff is recovered from the foodstuff wash and the clean foodstuff is ready to be cooked, eaten or both, even in the absence of a water rinsing step. In a preferred embodiment, however, the clean foodstuff is rinsed with water prior to being eaten or cooked.

Regarding the temperature of the foodstuff wash, the foodstuff wash is typically at a temperature from greater than 0.0 degrees centigrade to about 35 degrees centigrade.

It is noted that it is within the scope of the present invention to sell the foodstuff wash of the present invention ready for use or to sell the composition for cleaning foodstuff in a kit with instructions to dilute the composition with water to thereby produce the foodstuff wash described herein.

The examples which follow are provided to further illustrate and facilitate an understanding of the present invention. The examples are not meant to be limiting and modifications which fall within the spirit of the claims are intended to be within the scope and spirit of the present invention.

### EXAMPLES 1

Compositions for cleaning foodstuff were made by mixing the following components under conditions of moderate shear at about ambient temperature:

| Component | Weight Percent |
|---|---|
| Lactic acid | 36.0-40.0% |
| Phosphoric acid | 28.0-33.0% |
| Sodium dodecyl sulfate | 0.4-1.0% |
| Water | balance |

One part of each of the compositions for cleaning foodstuff made above were subsequently diluted with about 975 to about 1,250 parts of water to produce the foodstuff wash of the present invention.

### EXAMPLE 2

Lettuce leaves, about 250 g, were added to about three (3) liters of foodstuff wash prepared in Example 1. The lettuce leaves and foodstuff wash were stirred for about one (1) minute after which the lettuce leaves were removed and washed with tap water. The washed lettuce leaves, about 25 g, were placed in a Stomacher (e.g., blender) along with 75 ml of neutralizer (eg., Letheen broth) and blended for about 1.0 minute. One (1) milliliter of neutralizer from the blender was serially diluted as necessary and one (1) or one tenth (0.1) milliliter portions placed on petri dishes. About twenty (20) milliliters of Difco Microbial Content Test Agar was added to the petri dishes and after agar solidification, the dishes were placed in an incubator at 30° C. After about 24 to 48 hours, colony forming units were assessed and the results indicated the foodstuff washes prepared in Example 1 reduced the number of microorganisms present on lettuce by 3 fold compared to lettuce washed in tap water or 50 ppm hypochlorite (i.e., the typical active in conventional washes). The foodstuff wash reduced microorganisms about 1.5 fold more than commercially available Fit which employs about 0.5% by weight citric acid as the active. Microbial reductions are depicted for the foodstuff washes tested in the table which follows:

TABLE

| Product | Log₁₀ reduction |
|---|---|
| Example 1 | 0.5 |
| Fit | 0.25 |
| Hypochlorite | 0.03 |

The results obtained in Example 2 indicate that the foodstuff wash of the present invention unexpectedly acts as an excellent anti-microbial agent with active levels significantly below 1.0 weight percent.

What is claimed is:

1. A composition for cleaning foodstuff, the composition comprising:
(a) an organic acid;
(b) an inorganic acid; and
(c) a surfactant
wherein the composition results in a use solution having a pH that is below the pKa of the organic acid.

2. The composition for cleaning foodstuff according to claim 1 wherein the organic acid is acetic acid, citric acid, propionic acid, lactic acid or a mixture thereof.

3. The composition for cleaning foodstuff according to claim 1 wherein the organic acid makes up from about 3.0 to about 75.0% by weight of the composition for cleaning foodstuff.

4. The composition for cleaning foodstuff according to claim 1 wherein the inorganic acid is sulfuric acid, nitric acid, phosphoric acid or a mixture thereof.

5. The composition for cleaning foodstuff according to claim 1 wherein the inorganic acid makes up from about 5.0 to about 60.0% by weight of the composition for cleaning foodstuff.

6. The composition for cleaning foodstuff according to claim 1 wherein the surfactant is a cationic, nonionic, anionic, amphoteric or zwitterionic surfactant.

7. The composition for cleaning foodstuff according to claim 6 wherein the surfactant is anionic and an alkyl or alkyl ether sulfate.

8. The composition for cleaning foodstuff according to claim 1 wherein the composition for cleaning foodstuff has a pH of less than about 3.0.

9. A foodstuff wash comprising:
(a) one part of a composition for cleaning foodstuff comprising:
i) an organic acid;
ii) an inorganic acid; and
iii) a surfactant; and
(b) at least about 450 parts water.

10. The foodstuff wash according to claim 9 wherein the foodstuff wash comprises at least about 750 parts water.

11. A method for washing foodstuff comprising the steps of:
(a) contacting soiled foodstuff with a foodstuff wash which is a mixture comprising one part of a first part having
i) an organic acid;
ii) an inorganic acid;
iii) a surfactant; and
at least about 450 parts of a second part having water to produce clean foodstuff;
(b) removing the clean foodstuff from the foodstuff wash wherein the foodstuff wash is substantially free of alcohol, and the foodstuff wash has a pH which is less than the pKa of the organic acids.

12. The method for washing foodstuff according to claim 12 wherein the soiled foodstuff is soiled fish, meats, poultry, fruits or vegetables.

13. The method for washing foodstuff according to claim 12 wherein the contacting takes place in a flume.

14. The method for washing foodstuff according to claim 12 wherein the soiled foodstuff is sprayed or brushed with the foodstuff wash.

15. The method for washing foodstuff according to claim 12 wherein the soiled foodstuff is dipped into the foodstuff wash.
